(19) United States
(12) Patent Application Publication
(10) Pub. No.: US 2023/0342035 A1
(43) Pub. Date: Oct. 26, 2023

(54) METHOD AND APPARATUS TO IMPROVE BANDWIDTH EFFICIENCY IN A DYNAMIC RANDOM ACCESS MEMORY

(71) Applicant: Intel Corporation, Santa Clara, CA (US)

(72) Inventors: Todd A. HINCK, Arlington, MA (US); Archhana M, Morgan Hill, CA (US)

(21) Appl. No.: 18/215,907

(22) Filed: Jun. 29, 2023

(51) Int. Cl. G06F 3/06

(52) U.S. Cl. CPC G06F 3/0611; G06F 3/0644; G06F 3/0673

(57) ABSTRACT

Bandwidth efficiency is improved by reducing time to access a cache line in a DRAM chip. A memory array in the DRAM chip is internally segmented into two equal size portions, each portion having a plurality of banks. Each respective portion is internally segmented into two equal size sub-portions. A cache line in the memory array is accessed by accessing a first half of the cache line in parallel in all of the sub-portions and accessing a second half of the cache line in parallel in all of the sub-portions of the memory array after a gap time.

### FIELD

This disclosure relates to memory and in particular to configuration of volatile memory devices on a memory module.

### BACKGROUND

A memory module is a printed circuit board on which memory integrated circuits (“chips”) are mounted to another printed circuit board, such as a motherboard, via a connector (also referred to as a “socket”). The connector is installed on the motherboard and a memory module is inserted into the connector. The connector enables interconnection between a memory module and a circuit on the motherboard.

The memory module can include independent m-bit data channels to transfer data to/from the memory integrated circuits. Each memory integrated circuit on the memory module has an m-bit data bus. Read and write operations to the memory integrated circuits on the memory module are burst oriented. A burst read/write operation starts at a selected location in the memory integrated circuit and continues for a burst length (BL) of p.

For example, in a memory module with two independent 32-bit data channels, a single burst read operation accesses 512-bits (64 Bytes) from one of the memory integrated circuits using one of the independent channels with a burst length of 16 (16×32-bit=512-bits). 64 Bytes (512-bits) is a typical length of a processor cache line.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a memory module that includes a plurality of Dynamic Random Access Memory (DRAM) chips;

FIG. 2 is a block diagram of an embodiment of the memory module in a system 2;

FIG. 3 is a block diagram of a memory module that includes DRAM chips;

FIG. 4 is a table illustrating read gap time (tCCD_L) for DRAM I/O speeds from 8.0 Gbps to 17.6 Gbps;

FIG. 5 is a timing diagram illustrating a read of a 512 bit cache line from a pseudo split die in a DRAM chip with a 16-bit data bus;

FIG. 6 is a table illustrating write gap time (tCCD_L_WR) for DRAM I/O speeds from 8.0 Gbps to 17.6 Gbps;

FIG. 7 is a timing diagram illustrating a write of a 512 bit cache line to a pseudo split die in a DRAM chip with a 16-bit data bus;

FIG. 8 is a block diagram illustrating an example of the organization of blocks and subblocks in a memory device; and

FIG. 9 is a block diagram of an embodiment of a computer system that includes the memory module in FIG. 3.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

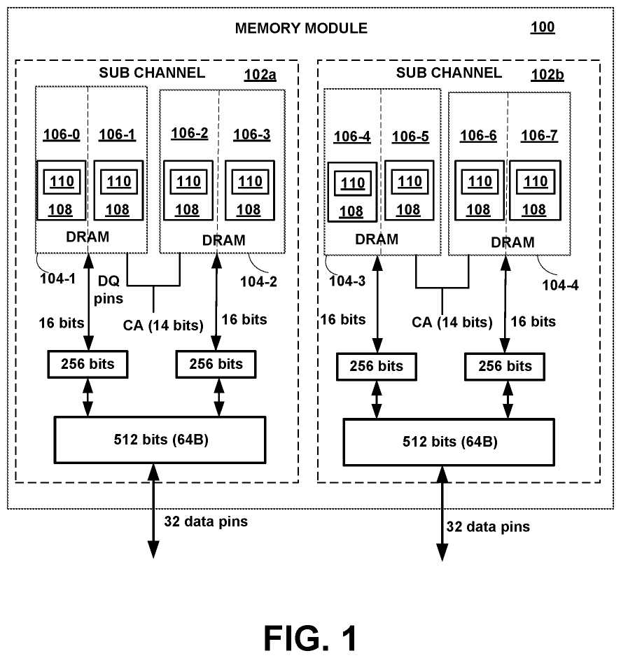

FIG. 1 is a block diagram of a memory module 100 that includes a plurality of Dynamic Random Access Memory (DRAM) chips 104-1, . . . , 104-4. The memory module 100 has two independent sub channels 102a, 102b with two DRAM chips 104-1, 104-2 in sub channel 102a and two DRAM chips 104-3, 104-4 in sub channel 102b.

Each of the DRAM chips 104-1, 104-2, 104-3, 104-4 in the memory module 100 is internally configured into bank groups 108 with each bank group having a plurality of banks 110. Each DRAM chip 104-1, 104-2, 104-3, 104-4 normally is a 32-bank (configured as eight bank groups 108 with 4 banks 110 for each bank group). However, for a x16 (16 bit data bus) DRAM chip, each DRAM chip 104-1, 104-2, 104-3, 104-4 can be split into two portions running in lock-step, each with 16-bank 106-0, 106-1 (configured as four bank groups 108 with 4 banks 110 for each bank group). Each portion 106-0, 106-1 of the DRAM chip 104-1, 104-2, 104-3, 104-4 that has a 16 bit data bus can store 128 bits of a 512-bit (64 byte) cache line.

A single read or write operation of 16n bits includes a 16n-bit wide, eight clock data transfer at the internal DRAM core in the DRAM chip and sixteen corresponding n-bit wide, one-half clock cycle transfer at the DQ pins on the DRAM chip. A read operation of a 512-bit (64 byte) cache line from sub channel 102a includes a 128-bit wide, eight clock data transfer at the internal DRAM core in portion 106-0 of DRAM chip 104-1, a 128-bit wide, eight clock data transfer at the internal DRAM core in portion 106-2 of DRAM chip 104-1, a 128-bit wide, eight clock data transfer at the internal DRAM core in portion 106-2 of DRAM chip 104-2 and a 128-bit wide, eight clock data transfer at the internal DRAM core in portion 106-3 of DRAM chip 104-2.

Portion 106-0 of DRAM chip 104-1 and portion 106-1 of DRAM chip 104-1 are read in parallel. Burst reads from DRAM chip 104-1 can be performed while burst reads from DRAM chip 104-2 are being performed.

Segmenting a DRAM chip 104-1 into two portions 106-0, 106-1 with each portion having 8 of the 16 banks requires two DRAM chips 104-1, 104-2 to store a 512-bit (64 byte) processor cache line for a sub channel 102a with each respective portion 106-0, 106-1, 106-3, 106-4 to store 128-bits (16B) (a quarter of the cache line). With each DRAM portion only providing 16 banks, the bandwidth efficient of the memory module is 20% or more lower normal operation with 32 banks.

Bandwidth efficiency of the DRAM chip is improved by reducing time to access a cache line in the DRAM chip. The DRAM chip is internally segmented into two equal size portions (subchannels), each portion having a plurality of banks. Each respective portion is internally segmented into two equal size sub-portions. Each sub-portion stores a quarter cache line.

A cache line is read by reading a first half of the cache line in parallel from the sub-portions of the DRAM chip and reading a second half of the cache line in parallel from the sub-portions of the DRAM chip after a read gap time.

A cache line is written to the DRAM chip by writing a first half of the cache line in parallel to the sub-portions of the DRAM chip and writing a second half of the cache line in parallel to the sub-portions of the DRAM chip after a write gap time.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

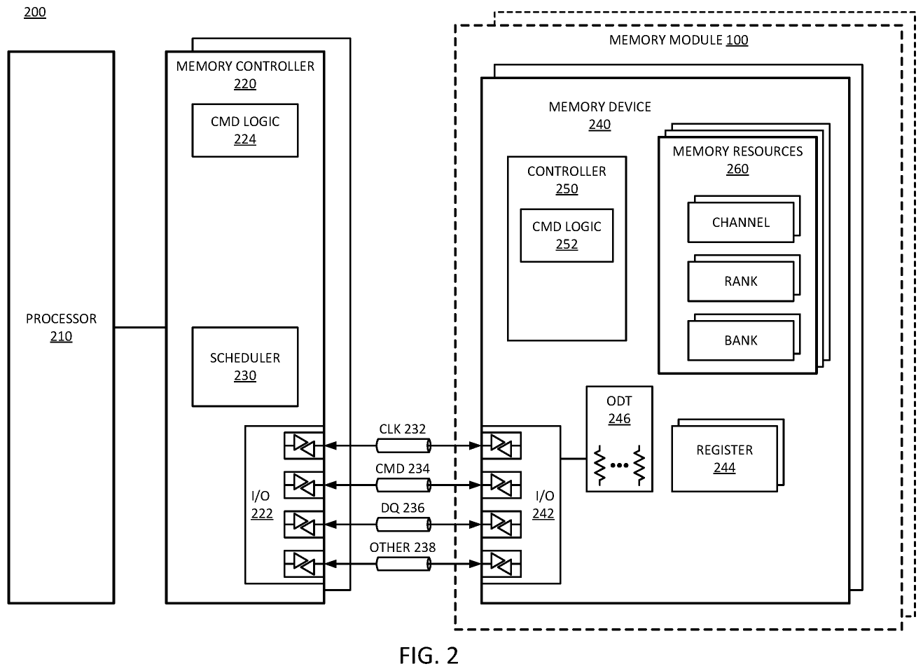

FIG. 2 is a block diagram of an embodiment of the memory module in a system 200. System 200 includes a processor 210 and elements of a memory subsystem in a computing device. Processor 210 represents a processing unit of a computing platform that may execute an operating system (OS) and applications, which can collectively be referred to as the host or the user of the memory. The OS and applications execute operations that result in memory accesses. Processor 210 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Accesses to memory can also be initiated by devices such as a network controller or hard disk controller. Such devices can be integrated with the processor in some systems or attached to the processer via a bus (for example, PCI express), or a combination. System 200 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, originally published in September 2012 by JEDEC), DDR5 (DDR version 5, originally published in July 2020), DDR6 (DDR version 6, currently in discussion by JEDEC), LPDDR3 (Low Power DDR version 3, JESD209-3B, August 2013 by JEDEC), LPDDR4 (LPDDR version 4, JESD209-4, originally published by JEDEC in August 2014), LPDDR5 (LPDDR version 5, JESD209-5A, originally published by JEDEC in January 2020), WI02 (Wide Input/Output version 2, JESD229-2 originally published by JEDEC in August 2014), HBM (High Bandwidth Memory, JESD235, originally published by JEDEC in October 2013), HBM2 (HBM version 2, JESD235C, originally published by JEDEC in January 2020), or HBM3 (HBM version 3 currently in discussion by JEDEC), or others or combinations of memory technologies, and technologies based on derivatives or extensions of such specifications. The JEDEC standards are available at www.jedec.org.

Descriptions herein referring to a “RAM” or “RAM device” can apply to any memory device that allows random access, whether volatile or nonvolatile. Descriptions referring to a “DRAM” or a “DRAM device” can refer to a volatile random access memory device. The memory device or DRAM can refer to the die itself, to a packaged memory product that includes one or more dies, or both. In one embodiment, a system with volatile memory that needs to be refreshed can also include nonvolatile memory.

Memory controller 220 represents one or more memory controller circuits or devices for system 200. Memory controller 220 represents control logic that generates memory access commands in response to the execution of operations by processor 210. Memory controller 220 accesses one or more memory devices 240. Memory devices 240 can be DRAM devices in accordance with any referred to above. In one embodiment, memory devices 240 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. As used herein, coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one embodiment, settings for each channel are controlled by separate mode registers or other register settings. In one embodiment, each memory controller 220 manages a separate memory channel, although system 200 can be configured to have multiple channels managed by a single controller, or to have multiple controllers on a single channel. In one embodiment, memory controller 220 is part of host processor 210, such as logic implemented on the same die or implemented in the same package space as the processor.

Memory controller 220 includes I/O (Input/Output) interface logic 222 to couple to a memory bus, such as a memory channel as referred to above. I/O interface logic 222 (as well as I/O interface logic 242 of memory device 240) can include pins, pads, connectors, signal lines, traces, or wires, or other hardware to connect the devices, or a combination of these. I/O interface logic 222 can include a hardware interface. As illustrated, I/O interface logic 222 includes at least drivers/transceivers for signal lines. Commonly, wires within an integrated circuit interface couple with a pad, pin, or connector to interface signal lines or traces or other wires between devices. I/O interface logic 222 can include drivers, receivers, transceivers, or termination, or other circuitry or combinations of circuitry to exchange signals on the signal lines between the devices. I/O interface logic 222 can also be referred to as Double Data Rate IO (DDRIO) logic. The exchange of signals includes at least one of transmit or receive. While shown as coupling I/O interface logic 222 from memory controller 220 to I/O interface logic 242 of memory device 240, it will be understood that in an implementation of system 200 where groups of memory devices 240 are accessed in parallel, multiple memory devices can include I/O interfaces to the same interface of memory controller 220. In an implementation of system 200 including one or more memory modules 100, I/O interface logic 242 can include interface hardware of the memory module 100 in addition to interface hardware on the memory device itself. Other memory controllers 220 can include separate interfaces to other memory devices 240.

The bus between memory controller 220 and memory devices 240 can be implemented as multiple signal lines coupling the memory controller 220 to memory devices 240. The bus may typically include at least clock (CLK) 232, command/address (CMD) 234, and write and read data (DQ) 236, and zero or more other signal lines 238. In one embodiment, a bus or connection between memory controller 220 and memory can be referred to as a memory bus. The signal lines for CMD can be referred to as a “C/A bus” (or ADD/CMD bus, or some other designation indicating the transfer of commands (C or CMD) and address (A or ADD) information) and the signal lines for write and read data DQ can be referred to as a “data bus.” In one embodiment, independent channels have different clock signals, C/A buses, data buses, and other signal lines. Thus, system 200 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 220 and memory devices 240. An example of a serial bus technology is 8B10B encoding and transmission of high-speed data with embedded clock over a single differential pair of signals in each direction. In one embodiment, CMD 234 represents signal lines shared in parallel with multiple memory devices. In one embodiment, multiple memory devices share encoding command signal lines of CMD 234, and each has a separate chip select (CS_n) signal line to select individual memory devices.

It will be understood that in the example of system 200, the bus between memory controller 220 and memory devices 240 includes a subsidiary command bus CMD 234 and a subsidiary data bus to carry the write and read data, DQ 236. In one embodiment, the data bus can include bidirectional lines for read data and for write/command data. In another embodiment, the subsidiary data bus DQ 236 can include unidirectional write signal lines for write and data from the host to memory, and can include unidirectional lines for read data from the memory to the host. In accordance with the chosen memory technology and system design, other signal lines 238 may accompany a bus or sub bus, such as strobe lines DQS. Based on design of system 200, or implementation if a design supports multiple implementations, the data bus can have more or less bandwidth per memory device 240. For example, the data bus can support memory devices that have either a x32 interface, a x16 interface, a x8 interface, or other interface. The convention “xW,” where W is an integer that refers to an interface size or width of the interface of memory device 240, which represents a number of data signal lines (pins) to exchange data with memory controller 120. The interface size of the memory devices is a controlling factor on how many memory devices can be used concurrently per channel in system 200 or coupled in parallel to the same signal lines. In one embodiment, high bandwidth memory devices, wide interface devices, or stacked memory configurations, or combinations, can enable wider interfaces, such as a x128 interface, a x256 interface, a x512 interface, a x1024 interface, or other data bus interface width.

Memory devices 240 and memory controller 220 exchange data over the data bus in a burst, or a sequence of consecutive data transfers. The burst corresponds to a number of transfer cycles, which is related to a bus frequency. In one embodiment, the transfer cycle can be a whole clock cycle for transfers occurring on a same clock or strobe signal edge (e.g., on the rising edge). Every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length 8 (BL8), and each memory device 240 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 240 represent memory resources for system 200. In one embodiment, each memory device 240 is a separate memory die. In one embodiment, each memory device 240 can interface with multiple (e.g., 2) channels per device or die. Each memory device 240 includes I/O interface logic 242, which has a bandwidth determined by the implementation of the device (e.g., x16 or x8 or some other interface bandwidth). I/O interface logic 242 enables the memory devices to interface with memory controller 220. I/O interface logic 242 can include a hardware interface, and can be in accordance with I/O interface logic 222 of memory controller 220, but at the memory device end. Multiple memory devices 240 can be connected in parallel to the same command and data buses. Multiple memory devices 240 can be connected in parallel to the same command bus, and are connected to different data buses. For example, system 200 can be configured with multiple memory devices 240 coupled in parallel, with each memory device responding to a command, and accessing memory resources 260 internal to each. For a Write operation, an individual memory device 240 can write a portion of the overall data word, and for a Read operation, an individual memory device 240 can fetch a portion of the overall data word. As non-limiting examples, a specific memory device can provide or receive, respectively, 8 bits of a 128-bit data word for a Read or Write transaction, or 8 bits or 16 bits (depending for a x8 or a x16 device) of a 256-bit data word. The remaining bits of the word are provided or received by other memory devices in parallel.

In one embodiment, memory devices 240 are disposed directly on a motherboard or host system platform (for example, a PCB (printed circuit board) on which processor 210 is disposed) of a computing device. In one embodiment, memory devices 240 can be organized into memory modules 100. In one embodiment, memory modules 100 represent dual inline memory modules (DIMMs). In one embodiment, memory modules 100 represent other organization of multiple memory devices to share at least a portion of access or control circuitry, which can be a separate circuit, a separate device, or a separate board from the host system platform. Memory modules 100 can include multiple memory devices 240, and the memory modules can include support for multiple separate channels to the included memory devices disposed on them. In another embodiment, memory devices 240 may be incorporated into the same package as memory controller 220, such as by techniques such as multi-chip-module (MCM), package-on-package, through-silicon via (TSV), or other techniques or combinations. Similarly, in one embodiment, multiple memory devices 240 may be incorporated into memory modules 100, which themselves may be incorporated into the same package as memory controller 220. It will be appreciated that for these and other embodiments, memory controller 220 may be part of host processor 210.

Memory devices 240 each include memory resources 260. Memory resources 260 represent individual arrays of memory locations or storage locations for data. Typically, memory resources 260 are managed as rows of data, accessed via word line (rows) and bit line (individual bits within a row) control. Memory resources 260 can be organized as separate channels, ranks, and banks of memory. Channels may refer to independent control paths to storage locations within memory devices 240. Ranks may refer to common locations across multiple memory devices (e.g., same row addresses within different devices). Banks may refer to arrays of memory locations within a memory device 240. Banks of memory can be divided into sub-banks with at least a portion of shared circuitry (e.g., drivers, signal lines, control logic) for the sub-banks. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one embodiment, memory devices 240 include one or more registers 244. Register 244 represents one or more storage devices or storage locations that provide configuration or settings for the operation of the memory device. In one embodiment, register 244 can provide a storage location for memory device 240 to store data for access by memory controller 220 as part of a control or management operation. In one embodiment, register 244 includes one or more Mode Registers. In one embodiment, register 244 includes one or more multipurpose registers. The configuration of locations within register 244 can configure memory device 240 to operate in a different “mode,” where command information can trigger different operations within memory device 240 based on the mode. Additionally, or in the alternative, different modes can also trigger different operation from address information or other signal lines depending on the mode. Settings of register 244 can indicate configuration for I/O settings (e.g., timing, termination or ODT (on-die termination) 246, driver configuration, or other I/O settings).

Memory device 240 includes controller 250, which represents control logic within the memory device to control internal operations within the memory device. For example, controller 250 decodes commands sent by memory controller 220 and generates internal operations to execute or satisfy the commands. Controller 250 can be referred to as an internal controller, and is separate from memory controller 220 of the host. Controller 250 can determine what mode is selected based on register 244, and configure the internal execution of operations for access to memory resources 260 or other operations based on the selected mode. Controller 250 generates control signals to control the routing of bits within memory device 240 to provide a proper interface for the selected mode and direct a command to the proper memory locations or addresses. Controller 250 includes command logic 252, which can decode command encoding received on command and address signal lines. Thus, command logic 252 can be or include a command decoder. With command logic 252, memory device can identify commands and generate internal operations to execute requested commands.

Referring again to memory controller 220, memory controller 220 includes scheduler 230, which represents logic or circuitry to generate and order transactions to send to memory device 240. From one perspective, the primary function of memory controller 220 can be considered to schedule memory access and other transactions to memory device 240. Such scheduling can include generating the transactions themselves to implement the requests for data by processor 210 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands, or a combination.

Memory controller 220 typically includes logic to allow selection and ordering of transactions to improve performance of system 200. Thus, memory controller 220 can select which of the outstanding transactions should be sent to memory device 240 in which order, which is typically achieved with logic much more complex that a simple first-in first-out algorithm. Memory controller 220 manages the transmission of the transactions to memory device 240, and manages the timing associated with the transaction. In one embodiment, transactions have deterministic timing, which can be managed by memory controller 220 and used in determining how to schedule the transactions.

Referring again to memory controller 220, memory controller 220 includes command (CMD) logic 224, which represents logic or circuitry to generate commands to send to memory devices 240. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 240, memory controller 220 can issue commands via I/O interface logic 222 to cause memory device 240 to execute the commands. In one embodiment, controller 250 of memory device 240 receives and decodes command and address information received via I/O interface logic 242 from memory controller 220. Based on the received command and address information, controller 250 can control the timing of operations of the logic and circuitry within memory device 240 to execute the commands. Controller 250 is responsible for compliance with standards or specifications within memory device 240, such as timing and signaling requirements. Memory controller 220 can implement compliance with standards or specifications by access scheduling and control.

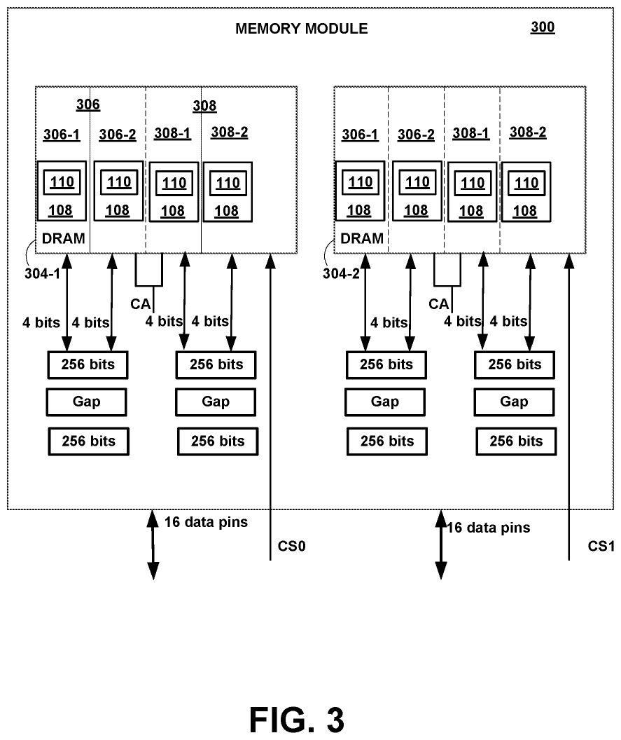

FIG. 3 is a block diagram of a memory module 300 that includes DRAM chips. In an embodiment, memory module 300 has four DRAM chips. Two of the four DRAM chips 304-1, 304-2 on module 300 are shown in FIG. 3. Each DRAM chip 304-1, 304-2 receives a respective Chip Select signal (CS0, CS1) to enable data access to/from memory resources (memory array) organized as banks in the DRAM chip 304-1, 304-2. The memory array in each DRAM chip 304-1, 304-2 is internally segmented into two equal size portions 306, 308 that can be referred to as a pseudo split die (PSD), with each respective portion 306, 308 internally segmented into two equal size sub-portions 306a, 306b, 308a, 308b. Each respective sub-portion 306a, 306b, 308a, 308b stores 128 bits (a quarter cache line) of a 512 bit cache line. Each DRAM chip 304-1, 304-2 has two subchannels (portions 306, 308).

The number of subchannels is inversely proportional to the number of banks in the memory array. For example, the number of subchannels are doubled (from x to 2x) then the number of banks per subchannel can be reduced by half (from y to y/2) with equivalent performance. Data is read/written from the DRAM chips 304-1, 304-2 in a 32B (256 bits) chunk.

A 64B (512 bit) cache line is read from DRAM chip 304-1 by reading a first 32B (256 bits) chunk (first half of the 512 bit cache line) from sub-portion 306a, 306b, 308a, 308b of the memory array in DRAM chip 304-1, followed by a read gap delay and reading a second 32B (256 bits) chunk (second half of the 512 bit cache line) from sub-portion 306a, 306b, 308a, 308b of the memory array in DRAM chip 304-1.

A 64B (512 bit) cache line is written to DRAM chip 304-1 by writing a first 32B (256 bits) chunk (first half of the 512 bit cache line) to sub-portion 306a, 306b, 308a, 308b of the memory array in DRAM chip 304-1, followed by a write gap delay and writing a second 32B (256 bits) chunk (second half of the 512 bit cache line) to sub-portion 306a, 306b, 308a, 308b of DRAM chip 304-1.

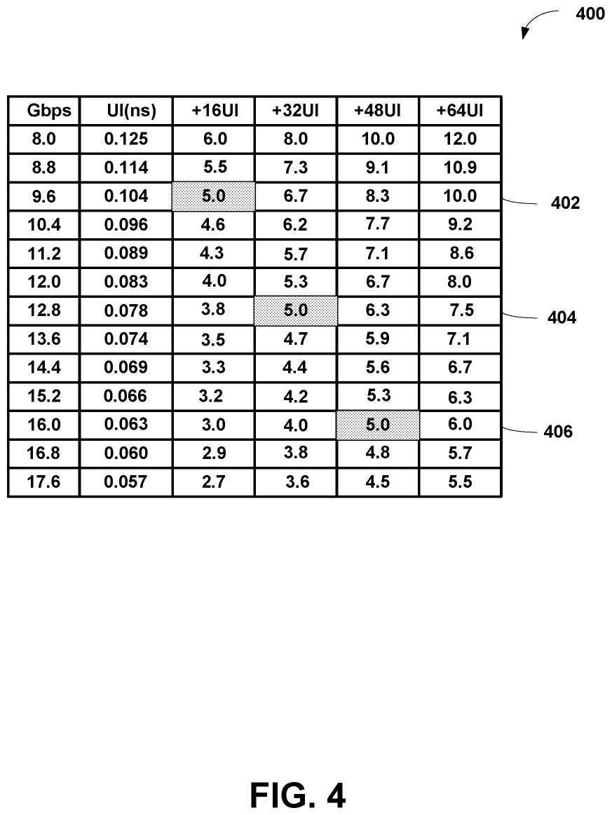

FIG. 4 is a Table 400 illustrating read gap time (tCCD_L) for DRAM I/O speeds from 8.0 Gbps to 17.6 Gbps. A clock cycle of the system clock is separated into multiple unit intervals (UIs), where each UI is a transfer cycle. The read gap time (tCCD_L) is the time between Column Address Strobes within the same bank group that is dependent on the internal burst length of the DRAM device.

As shown in row 402 of table 400, for DRAM I/O speeds up to 9.6 Gigabits per second (Gbps), a 5 nano seconds (ns) read gap time is 16 UIs. As shown in row 404 of table 400, for DRAM I/O speeds greater than 9.6 Gbps up to 12.8 Gbps, a 5 ns read gap time is 32 UIs. As shown in row 406 of table 400, for DRAM I/O speeds above 12.8 Gbps and up to 16.0 Gbps, the UI is 0.063 ns and the 5 ns gap time is 48 UIs. For DRAM I/O speeds above 16.0 Gpbs, the 5 ns gap time is 64UI.

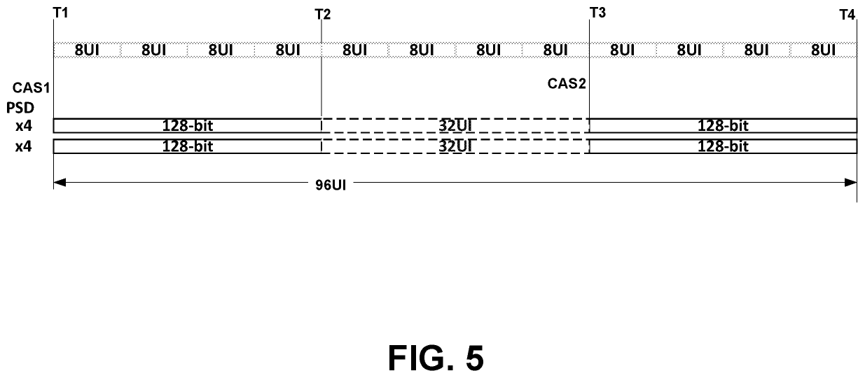

FIG. 5 is a timing diagram illustrating a read of a 512 bit cache line from a pseudo split die in a DRAM chip with a 16-bit data bus. The 512-bit cache line is read in response to a read command received from the memory controller in a burst (a sequence of consecutive data transfers). The burst corresponds to a number of transfer cycles, which is related to a bus frequency. In one embodiment, the transfer cycle can be a whole clock cycle for transfers occurring on the same clock or strobe signal edge (for example, on the rising edge).

In one embodiment, every clock cycle, referring to a cycle of the system clock, is separated into multiple unit intervals (UIs), where each UI is a transfer cycle. For example, double data rate transfers trigger on both edges of the clock signal (for example, rising and falling). A burst can last for a configured number of UIs, which can be a configuration that is stored in a register, or triggered on the fly. For example, a sequence of 32 consecutive transfer periods can be considered a burst length 32 (BL32), and a memory device can transfer data on each UI.

FIG. 5 will be described in conjunction with pseudo split die (PSD) 306 in DRAM 304-1 in FIG. 3 and table 400 in FIG. 4. At time T1, Column Address Strobe 1 (CAS1) selects a column to read in DRAM 304-1. From time T1 to time T2 (32 UIs), a burst of 32×4 bits (128 bits) is read from sub-portion 306-1 of pseudo split die (PSD) 306 and a burst of 32×4 bits (128 bits) is read from sub-portion 306-2 of pseudo split die (PSD) 306 in parallel to provide a burst of 32×4 bits×2 (256 bits). From time T1 to T2, a burst of 32×4 bits (128 bits) can be read from sub-portion 308-1 of pseudo split die (PSD) 308 and a burst of 32×4 bits (128 bits) can be read from sub-portion 308-2 of pseudo split die (PSD) 308.

T2 to T3 is the time between Column Address Strobes within the same bank group, also referred to the read gap time (tCCD_L) that is dependent on the internal burst length of the DRAM device. For DRAM I/O speeds up to 12.8 Gigabits per second (Gbps), a 5 nano seconds (ns) read gap time is 32 UIs. For DRAM I/O speeds above 12.8 Gbps and up to 16.0 Gbps, the 5 ns gap time is 48 UIs. For DRAM I/O speeds above 16.0 Gpbs, the 5 ns gap time is 64UI.

At time T3, Column Address Strobe 1 (CAS2) selects another column to read in DRAM 304-1. From time T3 to time T4, a burst of 32×4 bits (128 bits) is read from sub-portion 306-1 of pseudo split die (PSD) 306 and a burst of 32×4 bits (128 bits) is read from sub-portion 306-2 of pseudo split die (PSD) 306 in parallel to provide a burst of 32×4 bits×2 (256 bits).

For speeds up to 12.8 Gigabits per second (Gbps), the time to read a 512 bit cache line DRAM 304-1 is 96 UIs. For speeds above 12.8 Gbps, the time to read a 512 bit cache line DRAM 304-1 is 128 UIs.

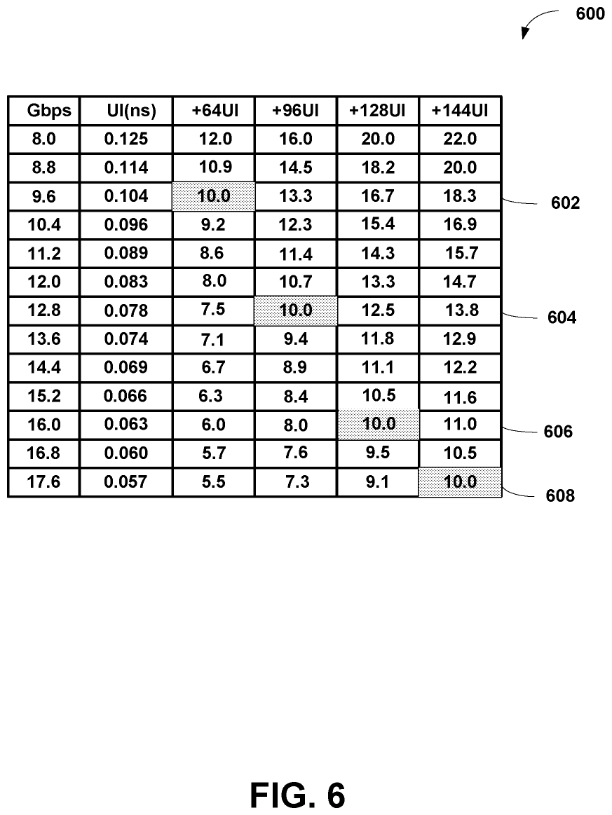

FIG. 6 is a Table 600 illustrating write gap time (tCCD_L_WR) for DRAM I/O speeds from 8.0 Gbps to 17.6 Gbps. A clock cycle of the system clock is separated into multiple unit intervals (UIs), where each UI is a transfer cycle. The write gap time (tCCD_L_WR) is the time between Column Address Strobes within the same bank group that is dependent on the internal burst length of the DRAM device.

As shown in row 602 of table 600, for DRAM I/O speeds up to 9.6 Gigabits per second (Gbps), a 10 nano seconds (ns) read gap time is 64 UIs. As shown in row 604 of table 600, for DRAM I/O speeds greater than 9.6 Gbps up to 12.8 Gbps, a 10 nano seconds (ns) read gap time is 96 UIs. As shown in row 606 of table 600, for DRAM I/O speeds greater than 12.8 Gbps up to 16 Gbps, the 10 ns gap time is 128 UIs. As shown in row 608 of table 600, for DRAM I/O speeds greater than 16 Gbps up to 17.6 Gbps, the 10 ns gap time is 144 UIs.

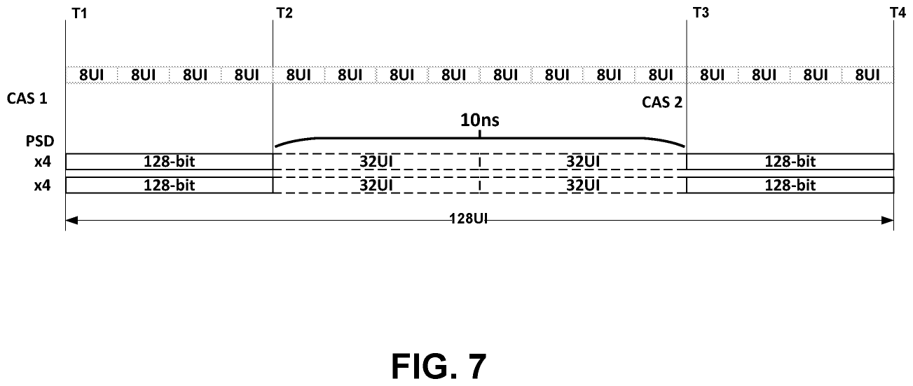

FIG. 7 is a timing diagram illustrating a write of a 512 bit cache line to a pseudo split die in a DRAM chip with a 16-bit data bus. FIG. 7 will be described in conjunction with pseudo split die (PSD) 306 in DRAM 304-1 in FIG. 3 and table 600 in FIG. 6. The 512 bit cache line is written in response to a write command from the memory controller.

At time T1, Column Address Strobe 1 (CAS1) selects a column to write in DRAM 304-1. From time T1 to time T2 (32 UIs), a burst of 32×4 bits (128 bits) is written to sub-portion 306-1 of pseudo split die (PSD) 306 and a burst of 32×4 bits (128 bits) is written to sub-portion 306-2 of pseudo split die (PSD) 306 in parallel to provide a burst of 32×4 bits×2 (256 bits).

Time T2 to time T3 is the time between Column Address Strobes within the same bank group, also referred to the write gap time (tCCD_L_WR) that is dependent on the internal burst length of the DRAM 304-1. For speeds up to 12.8 Gigabits per second (Gbps), a 10 ns write gap time is 64 UIs (minimum) or 96 UIs as shown in row 602 and row 604 in Table 6. For DRAM I/O speeds above 12.8 Gbps, the 10 ns gap time is 128 UIs+a multiple N of 16UI (N*16UI).

At time T3, Column Address Strobe 1 (CAS2) selects another column to read in DRAM 304-1. From time T3 to time T4, a burst of 32×4 bits (128 bits) is written to sub-portion 306-1 of pseudo split die (PSD) 306 and a burst of 32×4 bits (128 bits) is written to sub-portion 306-2 of pseudo split die (PSD) 306 in parallel to provide a burst of 32×4 bits×2 (256 bits).

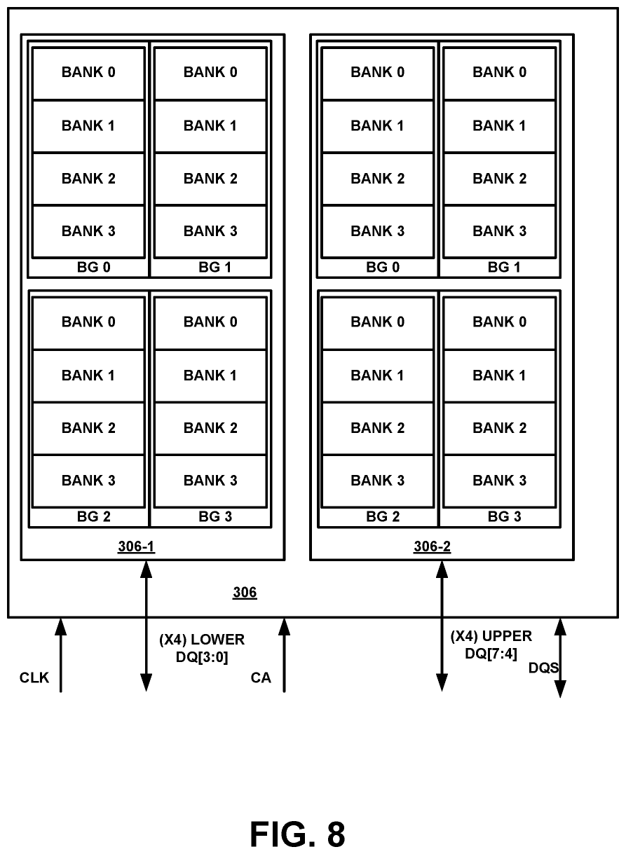

FIG. 8 is a block diagram illustrating an example of the organization of banks in bank groups in the PSD 306 in DRAM device 304-1 shown in FIG. 3. The pseudo split die 306 has four banks (Bank 0, Bank 1, Bank 2, Bank 3) and four bank groups (BG0, BG1, BG2, BG4), a total of 16 banks.

Column Address (CA) selects the bank group and the bank in the selected bank group. Data Strobe (DQS) selects the PSD 306. In response to a read operation to read data from the PSD 306, a burst of 32×4 bits (128 bits) is read from the selected bank in the selected bank group from sub-portion 306-1 of pseudo split die (PSD) 306 and is output on data pins DQ[3:0]. A burst of 32×4 bits (128 bits) is read from the selected bank in the selected bank group from sub-portion 306-2 of pseudo split die (PSD) 306 in parallel with the read from sub-portion 306-2 and is output on data pins DQ[7:4]. The read from the selected bank in the selected bank group from sub-portion 306-1 and sub-portion 306-2 of the PSD 306 provides a burst of 32×4 bits x 2 (256 bits) on data pins DQ[7:0].

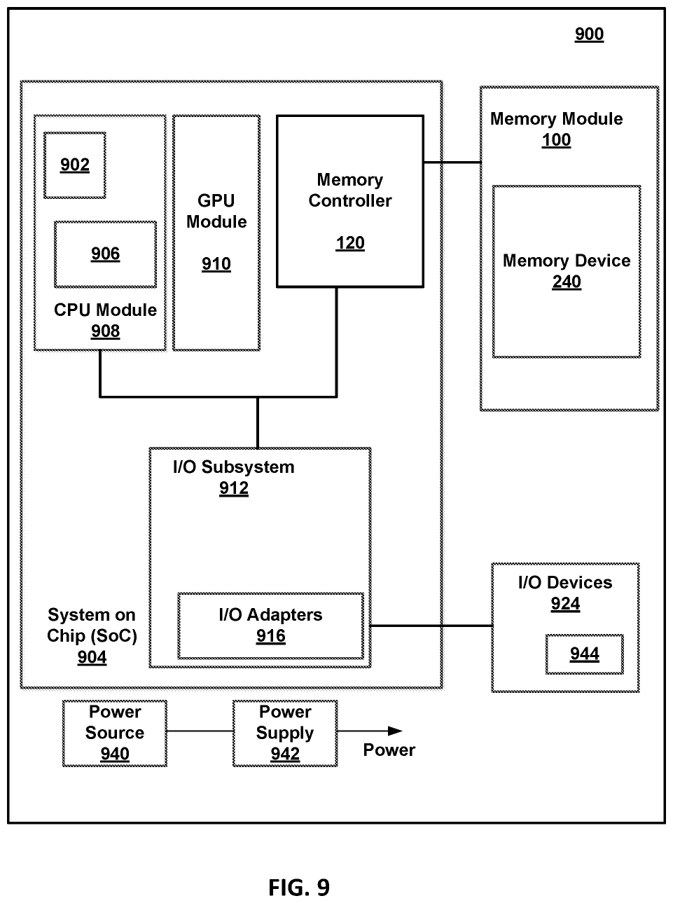

FIG. 9 is a block diagram of an embodiment of a computer system 900 that includes the memory module 300 in FIG. 3. Computer system 900 can correspond to a computing device including, but not limited to, a server, a workstation computer, a desktop computer, a laptop computer, and/or a tablet computer.

The computer system 900 includes a system on chip (SOC or SoC) 904 which combines processor, graphics, memory, and Input/Output (I/O) control logic into one SoC package. The SoC 904 includes at least one Central Processing Unit (CPU) module 908, a memory controller 120, and a Graphics Processor Unit (GPU) 910. In other embodiments, the memory controller 120 can be external to the SoC 904. The CPU module 908 includes at least one processor core 902, and a level 2 (L2) cache 906.

Although not shown, each of the processor core(s) 902 can internally include one or more instruction/data caches, execution units, prefetch buffers, instruction queues, branch address calculation units, instruction decoders, floating point units, retirement units, etc. The CPU module 908 can correspond to a single core or a multi-core general purpose processor, such as those provided by Intel® Corporation, according to one embodiment.

The Graphics Processor Unit (GPU) 910 can include one or more GPU cores and a GPU cache which can store graphics related data for the GPU core. The GPU core can internally include one or more execution units and one or more instruction and data caches. Additionally, the Graphics Processor Unit (GPU) 910 can contain other graphics logic units that are not shown in FIG. 9, such as one or more vertex processing units, rasterization units, media processing units, and codecs.

Within the I/O subsystem 912, one or more I/O adapter(s) 916 are present to translate a host communication protocol utilized within the processor core(s) 902 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 916 can communicate with external I/O devices 924 which can include, for example, user interface device(s) including a display 944 and/or a touch-screen display, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)). The display 944 to display data stored in the plurality of memory devices 240 in the memory module 100.

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

Power source 940 provides power to the components of computer system 900. More specifically, power source 940 typically interfaces to one or multiple power supplies 942 in computer system 900 to provide power to the components of computer system 900. In one example, power supply 942 includes an AC to DC (alternating current to direct current) adapter to plug into a wall outlet. Such AC power can be renewable energy (e.g., solar power) power source 940. In one example, power source 940 includes a DC power source, such as an external AC to DC converter. In one example, power source 940 or power supply 942 includes wireless charging hardware to charge via proximity to a charging field. In one example, power source 940 can include an internal battery or fuel cell source.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A memory device comprising:
Input/Output interface logic to couple to a memory controller; and
a memory array segmented into two equal size portions, each portion having a plurality of banks and segmented into two equal size sub-portions, a cache line in the memory array accessed by accessing a first half of the cache line in parallel in all of the sub-portions and accessing a second half of the cache line in parallel in all of the sub-portions of the memory array after a gap time.

2. The memory device of claim 1, wherein the plurality of banks are configured as four bank groups with four banks per bank group.

3. The memory device of claim 1, wherein the cache line in the memory array is read by reading a first half of the cache line in parallel from all of the sub-portions and reading a second half of the cache line in parallel from all of the sub-portions of the memory array after a read gap time.

4. The memory device of claim 3, wherein the a to read a cache line is 96 Unit Intervals (UI) and the read gap time is 32 UI for a DRAM I/O speed greater than 9.6 Gbps up to 12.8 Gbps.

5. The memory device of claim 1, wherein the cache line in the memory array is read in response to a read command received by the Input/Output interface logic from the memory controller.

6. The memory device of claim 1, wherein the cache line in the memory array is written by writing a first half of the cache line in parallel in all of the sub-portions and reading a second half of the cache line in parallel in all of the sub-portions of the memory array after a write gap time.

7. The memory device of claim 6, wherein a time to write a cache line is 128 Unit Intervals (UI) and the write gap time is 64 UI for a DRAM I/O speed greater than 9.6 Gbps up to 12.8 Gbps.

8. The memory device of claim 1, wherein the cache line in the memory array is written in response to a write command received by the Input/Output interface logic from the memory controller.

9. A system comprising:
a memory controller; and
a memory module, the memory module comprising:
Input/Output interface logic to couple to the memory controller; and
a memory device, the memory device comprising:
a memory array segmented into two equal size portions, each portion having a plurality of banks and segmented into two equal size sub-portions, a cache line in the memory array accessed by accessing a first half of the cache line in parallel in all of the sub-portions and accessing a second half of the cache line in parallel in all of the sub-portions of the memory array after a gap time.

10. The system of claim 9, wherein the plurality of banks are configured as four bank groups with four banks per bank group.

11. The system of claim 9, wherein the cache line in the memory array is read by reading a first half of the cache line in parallel from all of the sub-portions and reading a second half of the cache line in parallel from all of the sub-portions of the memory array after a read gap time.

12. The system of claim 11, wherein a time to read a cache line is 96 Unit Intervals (UI) and the read gap time is 32 UI for a DRAM I/O speed greater than 9.6 Gbps up to 12.8 Gbps.

13. The system of claim 9, wherein the cache line in the memory array is written by writing a first half of the cache line in parallel in all of the sub-portions and reading a second half of the cache line in parallel in all of the sub-portions of the memory array after a write gap time.

14. The system of claim 13, wherein a time to write a cache line is 128 Unit Intervals (UI) and the write gap time is 64 UI for a DRAM I/O speed greater than 9.6 Gbps up to 12.8 Gbps.

15. The system of claim 9, further comprising one or more of:
at least one processor communicatively coupled to the memory controller;
a display communicatively coupled to at least one processor; or
a power supply to provide power to the system.

16. A method comprising:
accessing, by a memory controller, a cache line in a memory array in a memory device communicatively coupled to the memory controller, the memory array segmented into two equal size portions, each portion having a plurality of banks and segmented into two equal size sub-portions by accessing a first half of the cache line in parallel in all of the sub-portions and accessing a second half of the cache line in parallel in all of the sub-portions of the memory array after a gap time.

17. The method of claim 16, wherein the plurality of banks are configured as four bank groups with four banks per bank group.

18. The method of claim 16, wherein the cache line in the memory array is read by reading a first half of the cache line in parallel from all of the sub-portions and reading a second half of the cache line in parallel from all of the sub-portions of the memory array after a read gap time.

19. The method of claim 18, wherein a time to read a cache line is 96 Unit Intervals (UI) and the read gap time is 32 UI for a DRAM I/O speed greater than 9.6 Gbps up to 12.8 Gbps.

20. The method of claim 16, wherein the cache line in the memory array is written by writing a first half of the cache line in parallel in all of the sub-portions and reading a second half of the cache line in parallel in all of the sub-portions of the memory array after a write gap time.
